(19) United States
(12) Patent Application Publication
(10) Pub. No.: US 2024/0416943 A1
(43) Pub. Date: Dec. 19, 2024

(54) Method and Device for Operating Safety Functions in a Vehicle

(71) Applicant: Bayerische Motoren Werke Aktiengesellschaft, Muenchen (DE)

(72) Inventor: Holger ULRICH, Muenchen (DE)

(21) Appl. No.: 18/740,612

(22) Filed: Jun. 12, 2024

(30) Foreign Application Priority Data
Jun. 13, 2023 (DE) 10 2023 115 295.5

(51) Int. Cl. B60W 50/14; B60W 10/18; B60W 30/12; B60W 50/00

(52) U.S. Cl. CPC B60W 50/14; B60W 10/18; B60W 30/12; B60W 50/0098; B60W 2050/0083; B60W 2050/146; B60W 2540/215

(57) ABSTRACT

A device for operating a set of safety functions of a vehicle is described. The device is configured to determine a user profile during a journey of the vehicle, wherein the user profile specifies a user status for each of the one or more safety functions of the set of safety functions. The device is furthermore configured to activate the set of safety functions according to a starting profile when the vehicle is started, wherein the starting profile specifies a starting status for each of the one or more safety functions of the set of safety functions. Furthermore, the device is configured to determine that for at least one safety function of the set of safety functions, the starting status deviates from the user status, and in reaction thereto to cause a message to be output to the user of the vehicle to the effect that the at least one safety function was started, deviating from the user profile, according to the starting profile.

### CROSS REFERENCE TO RELATED APPLICATION

This application claims priority under 35 U.S.C. § 119 from German Patent Application No. DE 10 2023 115 295.5, filed Jun. 13, 2023, the entire disclosure of which is herein expressly incorporated by reference.

### BACKGROUND AND SUMMARY

The invention relates to a method and a corresponding device which are configured to operate one or more safety functions in a vehicle.

A vehicle can have one or more safety functions which are designed to increase the driving safety of the vehicle. Exemplary safety functions are an emergency braking assistant, a lane keeping assistant, a lane changing assistant, etc. The operation of individual safety functions can be perceived as inconvenient by a user of the vehicle.

The present document relates to the technical problem of effectuating particularly convenient and safe operation of one or more safety functions in a (motor) vehicle.

The object is achieved by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for operating a set of safety functions of a (motor) vehicle is described. The set of safety functions can comprise one or more safety functions. Exemplary safety functions include:
an emergency braking function, which is configured to cause automated emergency braking of the vehicle; and/or
a lane keeping function, which is configured to keep the vehicle within a currently traveled lane in an automated manner; and/or
a lane change warning function, which is configured to cause the output of a warning message upon departure of a currently traveled lane of the vehicle.

The one or more safety functions can each be configured to analyze sensor data from one or more surroundings sensors of the vehicle, for example, to detect an obstacle and/or a lane marking in the surroundings of the vehicle. A measure can then be caused depending on the analysis of the sensor data, in particular depending on a detected obstacle and/or a detected lane marking. The measure can comprise the output of a warning message and/or an automatic intervention in the longitudinal and/or lateral guidance of the vehicle.

The device can be configured, when the vehicle is started, when it is first put into operation, or after a reset to factory settings, to activate the set of safety functions according to a base profile, wherein the base profile specifies a base status for each of the one or more safety functions of the set of safety functions. The base status for a safety function can provide, for example, that the safety function is activated with the maximum possible functional scope.

The device is configured to determine a user profile during a journey of the vehicle, wherein the user profile specifies a user status for each of the one or more safety functions of the set of safety functions. The user status of one or more safety functions can deviate from the respective base status. The user profile can be determined on the basis of one or more user inputs of the user during operation of the vehicle (which are caused, for example, at a user interface of the vehicle). The one or more user inputs can be directed to changing the status of at least one safety function (in relation to the base status). For example, it is possible to cause a safety function to be deactivated or the functional scope of a safety function to be reduced.

The device is furthermore configured, when the vehicle is started, to activate the set of safety functions according to a starting profile, wherein the starting profile specifies a starting status for each of the one or more safety functions of the set of safety functions. The starting status of a safety function can correspond to the base status. The starting status of a safety function can possibly be below the base status (e.g., having a reduced functional scope of the safety function or possibly having a deactivated safety function).

The status, in particular the starting status and/or the user status and/or the base status, of the individual safety functions can specify
whether the safety function is activated or deactivated; and/or
the functional scope with which the safety function is operated.

An activated status having a maximum possible functional scope can correspond here to the highest possible status, while a deactivated status can correspond to the lowest possible status. Furthermore, a gradation of the “level” of the status can be present depending on the functional scope.

The device is configured to determine that for at least one safety function of the set of safety functions, the starting status deviates from the user status. This can be the case in particular if it is necessary due to a norm, e.g., a legal norm and/or a norm of the producer of the vehicle, for the individual safety functions to each have a specific minimum status (e.g., a specific minimum functional scope) when the vehicle is started. A user input can have caused the user status of a safety function to fall below the minimum status of the safety function.

The device is furthermore configured, in reaction to the determination, to cause a message to be output (via the user interface of the vehicle) to the user of the vehicle to the effect that the at least one safety function was started deviating from the user profile according to the starting profile.

A particularly safe and convenient operation of the set of safety functions can be caused by starting the set of safety functions according to a starting profile, which possibly deviates from the user profile and possibly corresponds to a predetermined (safety) norm, and by outputting a message with respect to the deviation from the user profile.

The device can be configured, in reaction to a user input following the output of the message, to cause the set of safety functions to be operated according to the user profile.

The starting status can possibly deviate from the user status for multiple safety functions from the set of safety functions. The device can be configured to make it possible for the user to operate each of the multiple safety functions according to the user status by a single user input following the output of the message.

It can thus be made possible for the user of the vehicle in a convenient manner (possibly by a single user input at the user interface of the vehicle) to change back to the user profile from the starting profile after the vehicle is started. The convenience of the operation of the set of safety functions of the vehicle can thus be further increased.

The device can be configured to determine the starting profile on the basis of the user profile and on the basis of the (safety) norm. The norm can specify, for each of the one or more safety functions of the set of safety functions, a required minimum status of the respective safety function when the vehicle is started. The required minimum status of a safety function can specify
whether the safety function has to be activated when the vehicle is started; and/or
required minimum functional scope using which the safety function has to be operated when the vehicle is started.

It can be checked for each of the individual safety functions from the set of safety functions whether the user status of the safety function from the user profile goes beyond the required minimum status from the norm or not. The user status can be used as the starting status of the safety function for the starting profile if the user status goes beyond the required minimum status. Otherwise, the required minimum status from the norm can be used as the starting status of the safety function for the starting profile if the user status does not go beyond the required minimum status. A particularly safe and convenient operation of the safety functions can thus be caused.

According to a further aspect, a (road) motor vehicle (in particular a passenger vehicle or a truck or a bus or a motorcycle) is described, which comprises the device described in this document.

According to a further aspect, a method for operating a set of safety functions of a (motor) vehicle is described. The method comprises determining, during at least one journey of the vehicle, a user profile, wherein the user profile specifies a user status for each of the one or more safety functions of the set of safety functions. The method furthermore comprises activating, when the vehicle is started, the set of safety functions according to a starting profile, wherein the starting profile specifies a starting status for each of the one or more safety functions of the set of safety functions.

Furthermore, the method comprises determining that for at least one safety function of the set of safety functions, the starting status deviates from the user status, and in reaction to the determination, causing a message to be output to the user of the vehicle to the effect that the at least one safety function was started deviating from the user profile according to the starting profile.

According to a further aspect, a software (SW) program is described. The SW program can be configured to be executed on a processor (e.g., on a control unit of a vehicle), and to thus carry out the method described in this document.

According to a further aspect, a storage medium is described. The storage medium can comprise a SW program which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention is described in more detail hereinafter on the basis of exemplary embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIG. 2a shows an exemplary base profile of one or more safety functions;

FIG. 2b shows an exemplary user profile of one or more safety functions;

FIG. 2c shows an exemplary starting profile of one or more safety functions; and

FIG. 3 shows a flow chart of an exemplary method for operating one or more safety functions of a vehicle.

### DETAILED DESCRIPTION OF THE DRAWINGS

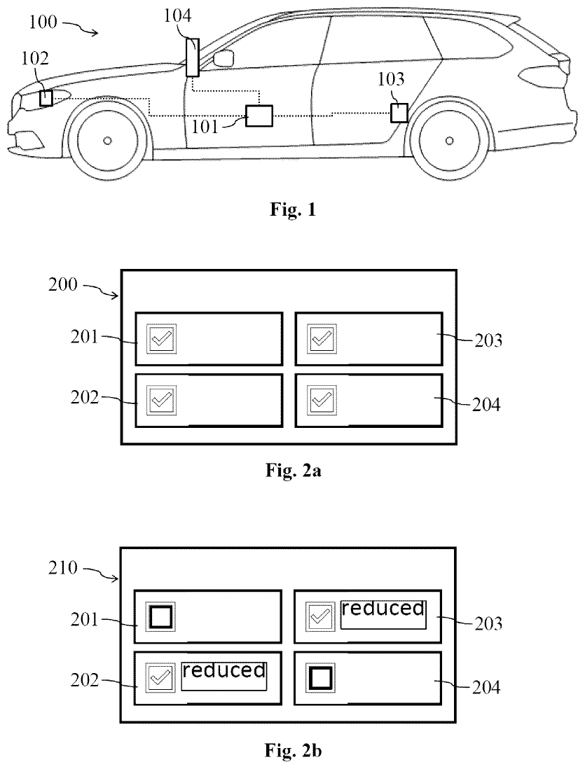

As described at the outset, the present document relates to safe and convenient operation of one or more safety functions of a vehicle. In this context, FIG. 1 shows an exemplary vehicle 100 having one or more surroundings sensors 102, which are each configured to acquire sensor data (which are also designated as surroundings data) with respect to the surroundings of the vehicle 100. Exemplary surroundings sensors 102 are a camera, a radar sensor, a lidar sensor, an ultrasonic sensor, etc.

A (control) device 101 of the vehicle 100 can be configured to evaluate the surroundings data, for example to detect one or more objects (e.g., other vehicles) in the surroundings of the vehicle 100. The device 101 can furthermore be configured to cause automated longitudinal and/or lateral guidance of the vehicle 100 on the basis of the surroundings data, in particular on the basis of the one or more detected objects. For this purpose, one or more longitudinal and/or lateral guidance actuators 103 (e.g., a drive motor, a braking device, and/or a steering device) of the vehicle 100 can be actuated.

One or more safety functions of the vehicle 100 can be provided and/or operated by the (control) device 101. One exemplary safety function is an emergency braking assistant, which is designed to cause automated emergency braking of the vehicle 100 in reaction to a detected obstacle. A further exemplary safety function is a lane keeping assistant, which is designed to steer the vehicle 100 in an automated manner back into its own lane when it is detected that the vehicle 100 is departing its own lane. A further exemplary safety function is the output of a lane change warning when it is detected that the vehicle 100 is departing its own lane and/or when an obstacle, such as another vehicle, is detected on the adjacent lane.

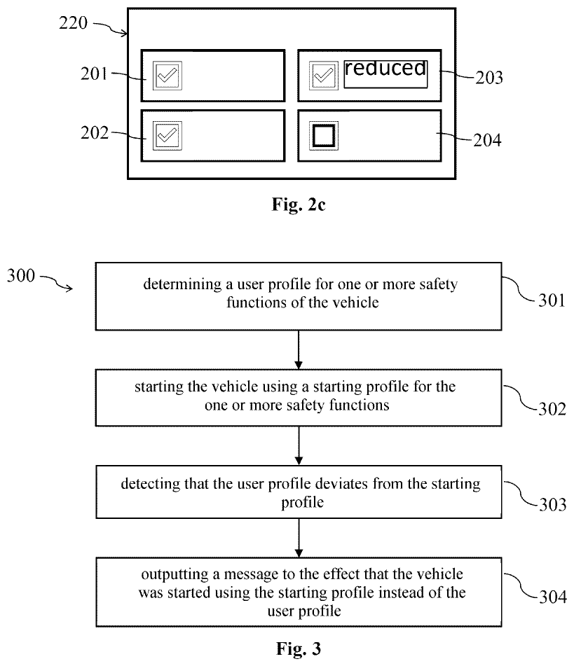

The vehicle 100 can be designed such that when the vehicle 100 is first put into operation, a set of safety functions is activated as a standard feature in order to enable the safest possible operation of the vehicle 100. FIG. 2a shows a base profile 200, which specifies the activation status of different safety functions 201, 202, 203, 204. It is illustrated by the checks that the respective safety function 201, 202, 203, 204 is activated. The vehicle 100 can first be put into operation according to the base profile 200, so that all safety functions 201, 202, 203, 204 from the set of safety functions 201, 202, 203, 204 are activated. The status of the individual safety functions 201, 202, 203, 204 according to the base profile 200 can be designated as the base status.

It can be made possible for the user of the vehicle 100, during operation of the vehicle 100, to deactivate one or more safety functions 201, 204 and/or to change, in particular to reduce, the functional scope of one or more safety functions 202, 203. The change of the status of a safety function 201, 202, 203, 204 can be caused via a user interface 104 of the vehicle 100. For example, the output of acoustic, optical, and/or haptic messages of a safety function 201, 202, 203, 204 can be perceived as uncomfortable by the user and the user can cause the safety function 201, 204 to be entirely deactivated or the functional scope of the safety function 202, 203 to be reduced.

The status of the individual safety functions 201, 202, 203, 204 caused by the user, which is also designated as the user status in this document, can be defined in a user profile 210 (cf. FIG. 2b). It can be specified here for each of the individual safety functions 201, 202, 203, 204 whether the respective safety function 201, 202, 203, 204 is activated or deactivated and/or whether and in which way the functional scope of the respective safety function 201, 202, 203, 204 was reduced.

The operation of a safety function 201, 202, 203, 204 typically results in increased driving safety. Furthermore, it can possibly be legally prescribed that a safety function 201, 202, 203, 204 is activated as a standard feature when beginning a journey of the vehicle 100. A starting profile 220 (see FIG. 2c) can be provided for the start of the vehicle 100, wherein the starting profile 220 specifies the status of the individual safety functions 201, 202, 203, 204, which is caused when the vehicle 100 is started. This status can be designated as the starting status.

The starting profile 220 can be determined on the basis of the user profile 210. Furthermore, a norm, such as a law or a specification of the vehicle producer, can be used which specifies for each of the individual safety functions 201, 202, 203, 204 whether the respective safety function 201, 202, 203, 204 is to be activated when the vehicle 100 is started and possibly with which functional scope the safety function 201, 202, 203, 204 is to be activated.

The (starting) status of the individual safety functions 201, 202, 203, 204 in the starting profile 220 can be determined according to one or more of the following rules:
if the status of the safety function 201, 202, 203, 204 was not changed in relation to the (base) status of the base profile 200, the status of the base profile 200 thus remains;
if the status of the safety function 201, 202, 203, 204 was changed in relation to the (base) status of the base profile 200, the status of the safety function 201, 202, 203, 204 is then dependent on the (user) status, caused by the user, from the user profile 210 and on the required minimum status defined in the norm;
if the status of the safety function 201, 202, 203, 204 was changed in relation to the (base) status of the base profile 200, the (user) status, caused by the user, from the user profile 210 is then used if it exceeds the required minimum status from the norm; and/or
if the status of the safety function 201, 202, 203, 204 was changed in relation to the (base) status of the base profile 200, the required minimum status from the norm is then used if the (user) status, caused by the user, from the user profile 210 is below the required minimum status from the norm.

It is possible to cause the individual safety functions 201, 202, 203, 204 to be activated according to the starting profile 220 when the vehicle 100 is started, in particular each time it is started. Furthermore, the user can be notified via the user interface 104 of the vehicle 100 that a starting profile 220 deviating from the user profile 210 was used to define the status of the one or more safety functions 201, 202, 203, 204. It can thereupon be made possible, via the user interface 104, for the user to select the user profile 210 instead of the starting profile 220 and to cause a corresponding change of the status of the one or more safety functions 201, 202, 203, 204.

Due to consumer protection requirements (such as Euro NCAP) it can possibly be necessary each time a new journey of the vehicle 100 is begun to cause a specific set of one or more safety functions 201, 202, 203, 204 (e.g., the emergency braking assistant, the lane keeping assistant, the lane change warning, etc.) to be automatically activated again, even if the user has previously deactivated one or more of these safety functions 201, 202, 203, 204 during a journey. The deactivation of a safety function 201, 202, 203, 204 can have been caused, for example, since the safety function was perceived by the user as inconvenient, in particular as patronizing, and/or since the safety function did not function reliably due to currently existing surroundings conditions (such as snowfall and/or snow-covered roadway).

As described above, the user of the vehicle 100 can be informed of it when one or more safety functions are reactivated when the vehicle is started. Furthermore, the user can be provided with the possibility of directly effectuating the last setting state again (i.e., the user status) of the one or more safety functions (according to the user profile 210).

The individual settings of the driver can be stored in a user profile 210 upon each operation. As soon as at least one of the individual settings is automatically changed when the next journey is started, the driver can be notified thereof via a notification (e.g., in a display of the user interface 104). When the driver interacts with this notification, they have the possibility of reestablishing their individual configuration of the last journey (according to the user profile 210) using few operating steps (e.g. using a single operating step).

FIG. 3 shows a flow chart of a (possibly computer-implemented) method 300 for operating a set of safety functions 201, 202, 203, 204 of a (motor) vehicle 100. The set of safety functions can comprise one or more, two or more, three or more, or four or more safety functions.

The method 300 comprises determining 301, during a journey of the vehicle 100, a user profile 210, wherein the user profile 210 specifies a user status for each of the one or more safety functions 201, 202, 203, 204 of the set of safety functions 201, 202, 203, 204. The user profile 210 can be determined on the basis of one or more user inputs, which are acquired, for example, via a user interface 104 of the vehicle 100. It can be made possible here for the user to change the status of one or more safety functions 201, 202, 203, 204, for example to deactivate a safety function 201, 204 or to reduce the functional scope of a safety function 202, 203. The individual safety functions 201, 202, 203, 204 can each have a base status when the vehicle is first put into operation or after the factory settings are reestablished. A user status deviating from the respective base status can be caused for one or more safety functions by the one or more user inputs.

The method 300 furthermore comprises activating 302, when the vehicle 100 is started, the set of safety functions 201, 202, 203, 204 according to a starting profile 220, wherein the starting profile 220 specifies a starting status for each of the one or more safety functions 201, 202, 203, 204 of the set of safety functions 201, 202, 203, 204. The starting status of a safety function 201, 202, 203, 204 can
correspond to the base status (if no change was performed by the user);
correspond to a required minimum status for the start of the vehicle 100; or
correspond to the user status (if the user status goes beyond the required minimum status and/or if the user status is between the base status and the minimum status).

Furthermore, the method 300 comprises determining 300 that, for at least one safety function 201, 202, 203, 204 of the set of safety functions 201, 202, 203, 204, the starting status deviates from the user status. In reaction to the determination 303 it is possible to cause (step 304) a message to be output to the user of the vehicle 100 to the effect that the at least one safety function 201, 202, 203, 204 was started, deviating from the user profile 210, according to the starting profile 220. Furthermore, it can be made possible for the user to cause, by a (possibly a single) user input, an operation of the set of safety functions 201, 202, 203, 204 according to the user profile 210.

Particularly safe and convenient operation of one or more safety functions 201, 202, 203, 204 in a vehicle 100 can be caused by the measures described in this document.

The present invention is not restricted to the exemplary embodiments shown. In particular, it is to be noted that the description and the figures are only to illustrate the principle of the proposed methods, devices, and systems by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for operating a set of safety functions of a vehicle, wherein the device is configured:
to determine a user profile during a journey of the vehicle, wherein the user profile specifies a user status for each of the one or more safety functions of the set of safety functions;
when the vehicle is started, to activate the set of safety functions according to a starting profile, wherein the starting profile specifies a starting status for each of the one or more safety functions of the set of safety functions;
to determine that, for at least one safety function of the set of safety functions, the starting status deviates from the user status; and
in reaction to a determination that the starting status deviates from the user status, to cause a message to be output to the user of the vehicle indicating that the at least one safety function has started deviating from the user profile according to the starting profile.

2. The device according to claim 1, wherein the device is configured, in reaction to a user input following the output of the message, to cause the set of safety functions to be operated according to the user profile.

3. The device according to claim 1, wherein
for multiple safety functions from the set of safety functions, the starting status deviates from the user status; and
the device is configured to enable the user to operate the multiple safety functions according to the user status by a single user input following the output of the message.

4. The device according to claim 1, wherein
the user profile is determined based on one or more user inputs of the user during the operation of the vehicle; and
the one or more user inputs are directed to changing the status of at least one safety function.

5. The device according to claim 1, wherein the starting status and/or the user status and/or a base status of a safety function specifies:
whether the safety function is activated or deactivated; and/or
a functional scope, using which the safety function is operated.

6. The device according to claim 1, wherein the set of safety functions comprises at least one of:
an emergency braking function, which is configured to cause automated emergency braking of the vehicle;
a lane keeping function, which is configured to keep the vehicle within a currently traveled lane in an automated manner; and
a lane change warning function, which is configured to cause output of a warning message upon departure from a currently traveled lane of the vehicle.

7. The device according to claim 1, wherein
the device is configured to determine the starting profile based on the user profile and a norm;
the norm specifies, for each of the one or more safety functions of the set of safety functions, a required minimum status of the respective safety function when the vehicle is started; and
the required minimum status of a safety function specifies at least one of:
whether the safety function has to be activated when the vehicle is started; and
a required minimum functional scope, using which the safety function has to be operated when the vehicle is started.

8. The device according to claim 7, wherein the device is configured, for each safety function of the set of safety functions,
to check whether the user status of the safety function from the user profile goes beyond the required minimum status from the norm or not; and
to use the user status as the starting status of the safety function for the starting profile in a case in which the user status goes beyond the required minimum status; and/or
to use the required minimum status as the starting status of the safety function for the starting profile in a case in which the user status does not go beyond the required minimum status.

9. The device according to claim 1, wherein
the device is configured, when the vehicle is started, when the vehicle is put into operation for the first time, or after a reset to factory settings, to activate the set of safety functions according to a base profile;
wherein the base profile specifies a base status for each of the one or more safety functions of the set of safety functions; and
the base status of the individual safety functions corresponds to or exceeds a respective starting status.

10. A method for operating a set of safety functions of a vehicle, the method comprising:
determining, during a journey of the vehicle, a user profile, wherein the user profile specifies a user status for each of the one or more safety functions of the set of safety functions;
activating, when the vehicle is started, the set of safety functions according to a starting profile, wherein the starting profile specifies a starting status for each of the one or more safety functions of the set of safety functions;
determining, that for at least one safety function of the set of safety functions, the starting status deviates from the user status; and
in reaction to a determination that the starting status deviates from the user status, causing a message to be output to the user of the vehicle indicating that the at least one safety function was started, deviating from the user profile, according to the starting profile.
